(19) United States
(12) Patent Application Publication
(10) Pub. No.: US 2012/0111843 A1
(43) Pub. Date: May 10, 2012

(54) Mobile, climbing robotic system to perform remote welds on ferrous materials

(76) Inventors: James Beard, Cookeville, TN (US); Stephen Canfield, Cookeville, TN (US); Steven Glovsky, Franklin, TN (US)

(21) Appl. No.: 13/291,791

(22) Filed: Nov. 8, 2011

Related U.S. Application Data
(60) Provisional application No. 61/456,416, filed on Nov. 8, 2010.

(51) Int. Cl. B23K 9/32

(52) U.S. Cl. 219/136

(57) ABSTRACT

An endless-track type mobile climbing vehicle containing a suspension apparatus and tool manipulator to perform trackless, guide-free welding in all positions or other manufacturing tasks. The invention can conform to a wide range of surface irregularities while maintaining contact between the track and adhering members and uniformly distributing the climbing loads on the adhering members giving the system a high payload to weight ratio. The vehicle with tool manipulator provides all necessary tool motion and stabilizes tool motion for tasks with strict requirements such as welding. The invention allows an operator to supervise and control the weld process through a controller. The invention allows the operator to specify weld motion control parameters for five axes and provides closed loop motion control to track the settings input by the welding operator. The invention also provides closed-loop tracking control to maintain the position of the robot along the longitudinal weld seam.

### CROSS REFERENCE TO RELATED APPLICATIONS

This application claims the priority of U.S. Provisional Application Ser. No. 61/456,416 entitled “Mobile, climbing robotic system to perform remote welds on ferrous structures” filed on Nov. 8, 2010, the entire contents and substance of which are hereby incorporated in total by reference.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

Welding is a common joining technique for many materials and the most common bonding method for metals. Welding is a commonly automated manufacturing technique for many metal-based products. However, there remain a number of systems that exist at a size, scale or location that do not permit traditional methods of automated welding. Methods that have been proposed, developed and or implemented to provide some level of mechanization or automation to these types of systems might be placed in one of three categories:

### 1) Traditional Serial-Architecture Type Robots Mounted on Fixed or Moving Base:

This approach makes use of industrial welding robots (generally serial architecture type) located in a facility designed to manipulate large scale manufactured components. In many cases, the base of the conventional manipulator may be mounted to a larger manipulator, for example a gantry system. This approach has several difficulties that generally limit its use: 1) it requires significant capital investment to design and install such a system, which affects the entire manufacture process, 2) This facility is at a fixed location and 3) it is difficult to access many portions of a large structure when assembly begins on a large system.

### 2) Mechanized Welding Tractor Mounted on Fixed Guide System

This approach again makes use of commercially-available, mechanically-guided weld mechanization systems that operate on a fixed guide or rail. These mechanically guided systems generally have 3-4 degrees of freedom (dof), with relatively small range of motion (typically less than 300 mm travel along a linear axis) and operate along a pre-installed mechanical guide or track. The systems can be designed to specific jobs and have a wide range of applications. These systems can operate fully in open loop with a welding operator guiding the motion, or may provide some level of sensing and closed-loop control. The primary difficulty with these systems lies in the requirement to pre-install the mechanical guide or track. This job is generally deemed a non-value added process, and may represent a significant portion of the weld process. Further, the pre-installation process may limit the flexibility of the process in manufacturing; it generally is not feasible to leave the track installed for multiple manufacturing operations.

### 3) Mobile-Platform Type Weld Systems:

Mobile-platform type weld systems represent the third approach to mechanizing weld processes on systems of large scale and size. These consist of a mobile platform that obtains locomotion and the ability to traverse a surface without the need for a pre-installed track or rail system. They are generally small, man-portable, and may employ mechanical guidance based on a physical feature, manual guidance by an operator, or use some type of closed loop control for guidance based on sensing some feature associated with the weld seam. Several commercial products of mobile welding systems are available, most designed to operate on a horizontal surface performing a down hand weld. Some of these mobile welding carriages are equipped with suspended electro or permanent magnets or magnetic wheels or tracks for use in all position welding. However, these carriages in general have a few key disadvantages, such as loss of holding strength from the magnets on non-flat surfaces, inability to adapt to curved surfaces or protrusions (for example weld seams) on a generally flat surface, and localization of the holding forces on to a small number of the adhering members when multiple magnetic adhering members are used. These disadvantages have limited their widespread use of mobile welding carriages in automating welding operations in out of position welds. The prior art shows carriages or vehicles for use with welding or other similar manufacturing operations of a few primary types: carriages with suspended magnets, magnetic wheels, or magnetic endless tracks or chains. Examples of these are presented as follows.

U.S. Pat. Nos. 3,764,777, 5,853,655, 6,627,004 and Fisher, Tache and Siegwart (2008) show variations of a welding and cutting carriage with magnetic wheels and positioning arm for performing manufacturing tasks on flat or uniformly curved surfaces. The magnetic wheel systems are affixed to a rigid carriage, which will cause some of the wheels, when four or more wheels are used, to detach when operating on non-flat or non-uniform surfaces causing degradation in holding power.

U.S. Pat. No. 7,309,464 shows a steerable magnetic wheel carriage with wheel frames supported on the carriage frame. The magnetic wheel systems are affixed to a frame which will cause some of the wheels, when four or more wheels are used, to detach when operating on non-flat or non-uniform surfaces causing degradation in holding power.

US Patent application publication US 2010/0176106 A1 shows a magnetic wheel carriage with magnetic wheels that rotate about axes that are able to change orientation relative to the carriage frame. The additional mobility in the wheel axes allow a larger number of wheels to make contact with a climbing surface when operating on non-flat or non-uniform climbing surfaces. However, under equilibrium the loads are transferred according to the relative compliance of the carriage frame and wheel axle system and in general will be localized to a small number of the magnetic wheels causing degradation in holding power.

U.S. Pat. No. 5,435,405 shows an example of a type of climbing carriage or vehicle that contains magnets or similar adhering members attached to endless tracks, with multiple magnets attaching to the climbing surface at any given time. However, these systems tend to either place the magnets on a track without a track guide or mechanism between the end wheels (for example U.S. Pat. No. 5,884,642 or Shen and Shen, 2005) and rely on tension in the track to transfer climbing forces to the adhering members, or on a track with a rigid track guide limiting the ability to conform to a non-uniform climbing surfaces (for example U.S. Pat. No. 5,487,440, Kim et al., 2008) or a guide that has some flexibility but for purposes of pushing in a single direction on the track to make contact with the climbing surface (for example U.S. Pat. No. 4,789,037). When climbing the loads required to maintain equilibrium are transferred to the adhering members according to the relative compliance of the carriage frame and endless track system and in general will be localized to a small number of the adhering members causing degradation in holding power.

Xu and Ma (2002) shows an endless-track type climbing vehicle with type of climbing vehicle with magnets called magnetic suckers. A load distribution mechanism is presented as a three link member connected to the vehicle body with a single spring. The article does not show how the endless track would connect with the load scatter mechanism or how forces are transferred from the track to the mechanism. Further, as presented, the load scatter mechanism localizes moment-balance forces to the leading portion of the load scatter mechanism and similarly the leading edge of the endless track.

U.S. Pat. No. 7,498,542 shows control method and system for trackless all-position welding based on an endless-track type climbing vehicle, tracks here called caterpillar belts. This vehicle places the adhering magnets on a track without a track guide or mechanism between the end wheels and thus relies on tension in the track to carry all climbing forces. This localizes the climbing forces on the magnets lying on the outer ends of the track contact region and degrades the payload capacity of the operating system.

Endless track-type vehicles with adhering members attached to the exterior of the endless track also generally share an additional characteristic of varying pitch length between a driving wheel or sprocket and the climbing surface as the endless track revolves around the driving wheels or sprockets. This variable pitch results in a non-uniform velocity ratio between the drive wheel or sprocket rotation and translation of the vehicle over the climbing surface. This is a problem in manufacturing operations such as welding where precise, controlled travel speeds are required to maintain the quality of the weld process.

Collectively, the prior art demonstrates mobile carriages that meet the primary navigation and control requirements to carry out weld operations in all positions. However, these devices contain several limitations that have restricted their widespread use in manufacturing, including the ability to climb over surfaces with variations or regularities, efficient use of the adhering members by distributing the climbing load in an improved fashion, and maintaining uniform, stabilized motion of the weld torch.

This invention presents a mobile welding system that addresses these issues by providing multiple adhering members, attached to an endless track passing through a flexible suspension capable of accommodating irregularities in the climbing surface, with a load distributing mechanism that is able to distribute loads required for equilibrium among the adhering members causing maximizing holding power of the vehicle in all weld positions over non uniform climbing surfaces, and a means for stabilizing torch motions.

### BRIEF SUMMARY OF THE INVENTION

The invention described in this document creates a mobile welding platform capable of climbing all positions, flat, inverted and upside down positions while carrying and manipulating welding or other manufacturing tools. This invention allows a welding operator to perform a weld in a remote fashion in a variety of positions including flat surfaces, inverted surfaces horizontal or vertical, butt welds, lap welds and fillet welds. The invention allows the weld operations to occur surfaces that are not uniform, and provides a high payload to weight ratio of the vehicle by effective use of the adhering members through optimized load distribution.

The invention allows a weld operator to supervise and control the weld process through a hand-held controller that provides feedback of the weld process and allows control of all actuated motions on the welding vehicle that include two degree of freedom control of the weld vehicle and up to five degree of freedom control of the weld torch. The invention allows the weld operator to specify weld motion control parameters for five axes, three translations of the weld torch and two rotations of the weld torch (about the axes orthogonal to the welding access). The invention provides closed loop motion control on all five axes to track the settings input by the welding operator while rejecting disturbances. The invention also provides closed-loop tracking control to maintain the position of the robot along the longitudinal weld seam. The invention achieves this through the following:

1) The invention defines a prescribed magnetic field created by the permanent magnet tracks allowing adaptation with all welding type equipment, particularly welding processes that are most sensitive to external magnetic field (for example pulsed-arc GMAW type weld magnetic). This also allows the torch to be placed in many locations around the mobile platform, and it allows compact design, fit into compact areas by allowing the torch to be near magnetic tracks.

2) The welding platform of this invention integrates a multi-link suspension apparatus that distributes climbing loads to maximize the system payload to weight ratio.

3) The welding platform of this invention integrates a multi-link I suspension apparatus that is adaptive to irregularities in the climbing surface.

4) The invention system contains a torch manipulator that is independently suspended from the tractor. Thus it isolates undesirable motions in the tractor from the torch. This lowers the control requirements on the tractor, allowing it to be small and control only the torch component. This keeps high resolution control components small, reduced mass, reduced dynamic control authority needed. This reduces the size and cost of the torch manipulator.

5) The invention integrates the torch manipulator and mobile platform in a reconfigurable and modular arrangement to position the torch anywhere inside, outside or around the platform, within a minimal distance of the permanent magnet tracks, inside or outside, in front or behind, to achieve a large range of weld types.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows an isometric view of the mobile climbing welding vehicle which includes two endless track units and a chassis, a commercial wire feed and torch and torch manipulator.

FIG. 2 shows a side view of the mobile climbing welding vehicle.

FIG. 3 shows an end view of the mobile climbing welding vehicle.

FIG. 4 shows a single endless track unit.

FIG. 5 shows a single endless track unit with the internal components exposed.

FIG. 6 shows the multi-link suspension apparatus isolated from the track unit.

FIG. 7 shows the universally mounted torch manipulator.

FIG. 8 shows the details of the universal adaptive mount with suspension.

FIG. 9 shows the details of the gauge wheels.

FIG. 10 shows the details of the primary torch transverse axis on the torch manipulator.

FIG. 11 shows the details of the torch toolbar and torch holder with torch attached.

FIG. 12 shows a magnetic foot member.

FIG. 13 shows an illustration of the magnetic field around a single foot member.

FIG. 14 shows a collection of the magnetic foot members on the endless track.

FIG. 15 shows an illustration of the magnetic field in a ferrous climbing surface when two endless tracks with attached magnetic adhering members are in contact with the surface.

FIG. 16 shows a flow chart for closed loop control on torch pattern, which coordinates control of forward travel speed, lateral travel motion (position, velocity, dwells at the end positions).

FIG. 17 shows a flow chart for a closed loop control on torch motion along the axis of the torch.

FIG. 18 shows a flow chart for closed loop control of torch work angle (rotation about the axis of the weld seam).

FIG. 19 shows a flow chart for closed loop control of torch travel angle (rotation about an axis perpendicular to the weld seam and parallel to the climbing surface).

FIG. 20 shows a flow chart for closed-loop control of the distance between the center-line of the robot and the weld seam.

FIG. 21 shows a flow chart for closed-loop control of the distance from the torch center to the axis of the weld seam.

FIG. 22 shows a hand-held controller that is used by an operator to control the endless track vehicle during operation.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

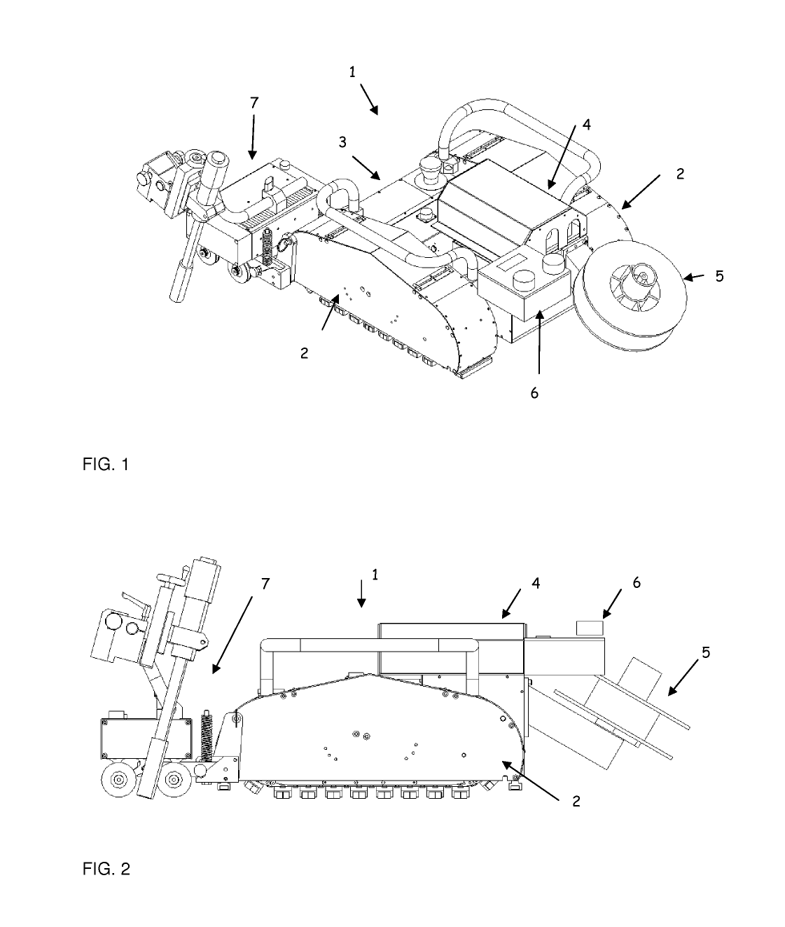

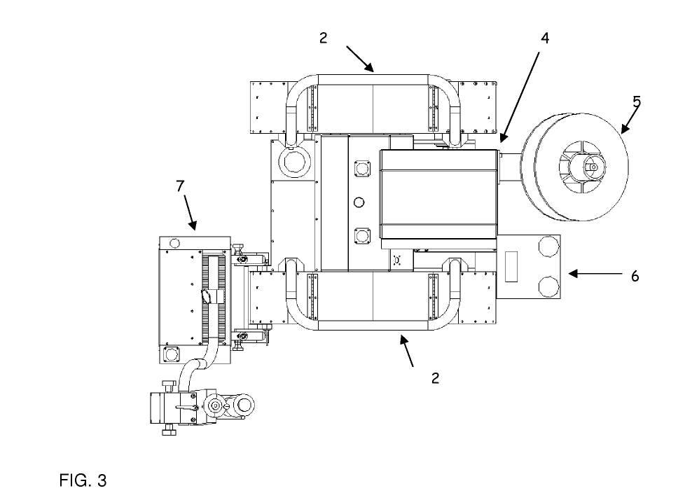

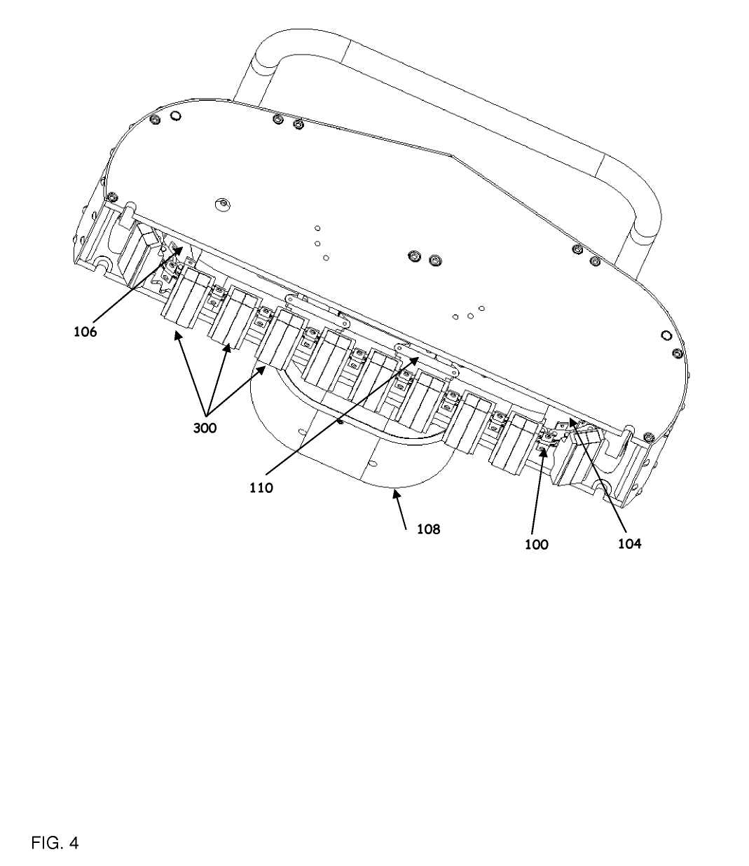

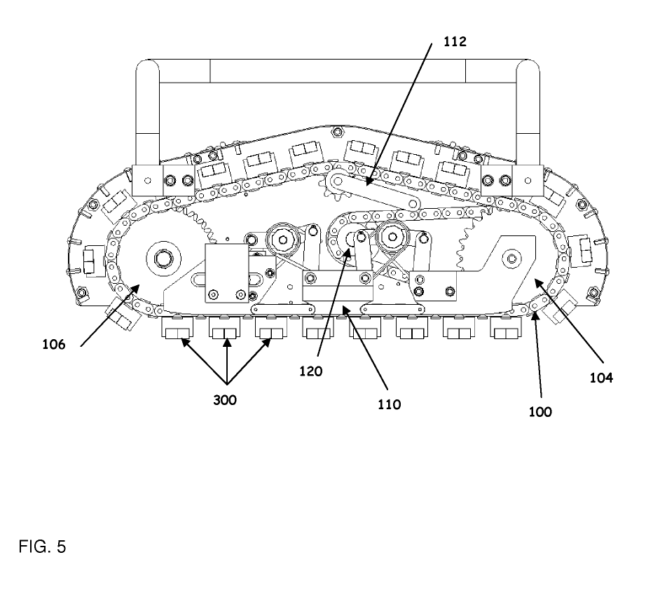

The mobile endless track welding vehicle (1) is illustrated in FIGS. 1, 2, and 3 here the endless track units (2) are connected to a chassis (3). The weld support tools can also be attached to the chassis and may consist of a commercial wire feed unit (4), spool of welding wire (5) and welding feed and/or power system controls (6). The universally-mounted torch manipulator (7) is attached to one of multiple mounting locations on a track unit or chassis. The track units are geometrically similar and symmetric; one is shown in FIG. 4. The endless track unit consists of an endless track (100) with a collection of permanent magnet feet (300) attached to the track. The endless track (100) passes around a drive sprocket (104) and track sprocket (106) and passes through the multi-link suspension apparatus (110). A drive unit (108) drives the drive sprocket (104) and or track sprocket (106). FIG. 5 shows the internal components in the track unit. The track drive sprocket (104) is pivotally attached to the mobile platform chassis and connected through a drive chain to the transmission drive sprocket (120). The endless track (100) travels around the drive sprocket (106) and track sprocket, through the multi-link suspension apparatus (110) and engages the track tension mechanism (112). The multi-link suspension apparatus is shown isolated from the track unit in FIG. 6. The multi-link suspension apparatus consists of a track guide member (130), load force dyads (132) and force transfer devices (134). The multi-link suspension apparatus serves multiple roles; it allows the track to adhere to uneven track surfaces, it distributes the load in a preferred manner over the individual magnetic elements attached to the endless track, and it allows the mobile climbing robotic welding system to operate in horizontal, vertical and inverted orientations.

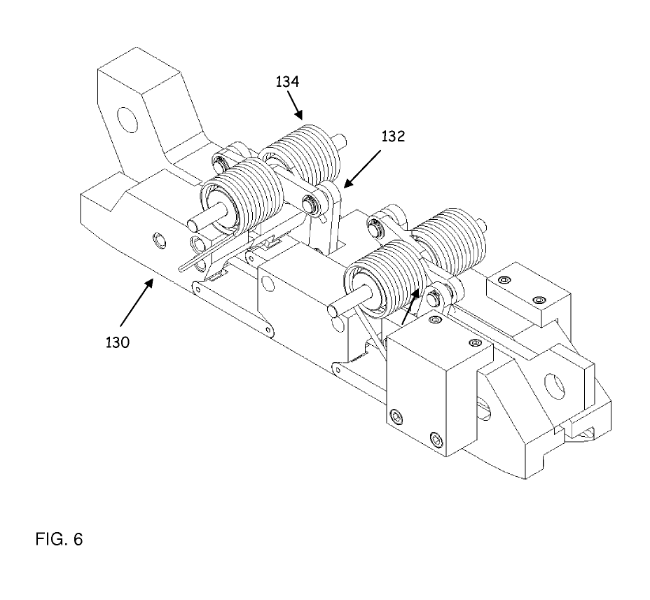

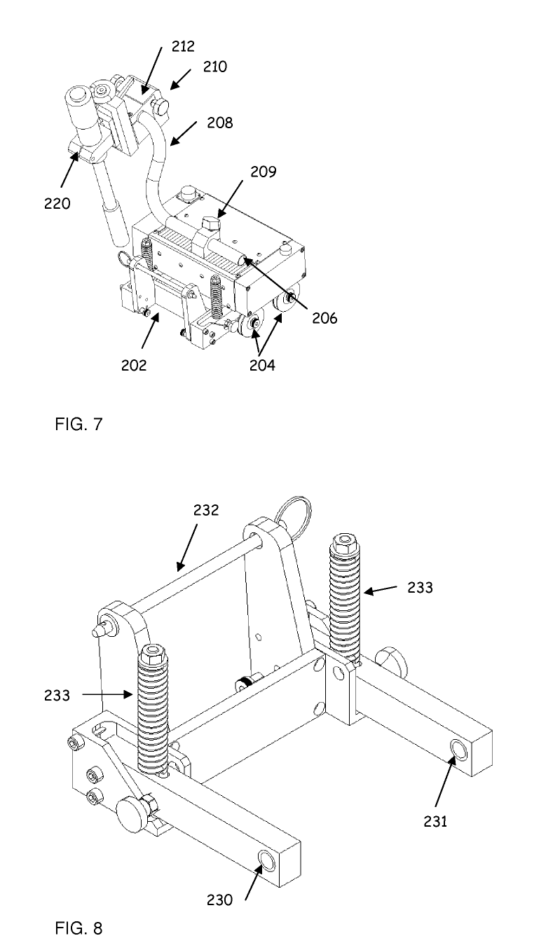

FIG. 7 shows the universally-mounted torch manipulator or torch manipulator. The torch manipulator connects to the mobile platform through a universal, sprung adaptive mount (202). A collection of gauge wheels (204) control the position and orientation of the torch manipulator to the climbing surface. The torch manipulator provides the primary transverse sliding axis (206) that supports the torch toolbar (208) through a rotational quick mount (209). The torch holder (210) attaches to the torch toolbar (208) through a rotational quick mount (212). The torch holder provides a translational degree of freedom, torch depth and an orientation degree of freedom, work angle. The torch (222) mounts in the torch holder through a rotational, adjustable depth quick connection (220).

FIG. 8 shows the details of the universal spring adaptive mount. In this embodiment the universal adaptive mount has three connections points, pivots at (230), (231) and (232). Springs (233) provide a force on the torch manipulator toward the climbing surface.

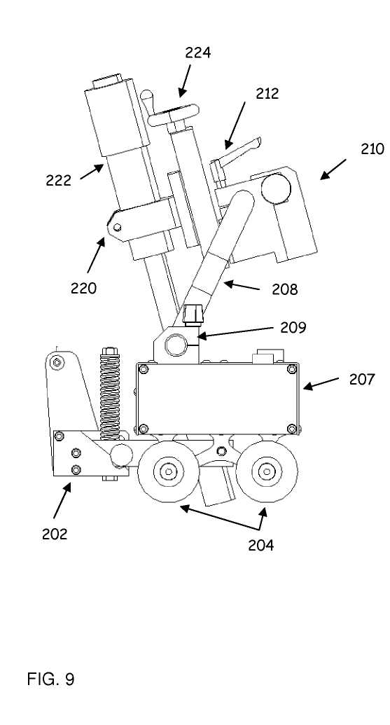

FIG. 9 shows a side view of the torch manipulator. The torch manipulator connects to the mobile platform through a universal, sprung adaptive mount (202). A collection of gauge wheels (204) control the position and orientation of the torch manipulator to the climbing surface. The torch manipulator provides the primary transverse sliding axis drive unit (207) that supports the torch toolbar (208) through a rotational quick mount (209). The torch holder (210) attaches to the torch toolbar (208) through a rotational quick mount (212). The torch holder provides a translational degree of freedom, torch depth and an orientation degree of freedom, work angle. The torch (222) mounts in the torch holder through a rotational, adjustable depth quick connection (220). An adjustable torch depth control axis (224) can also be provided.

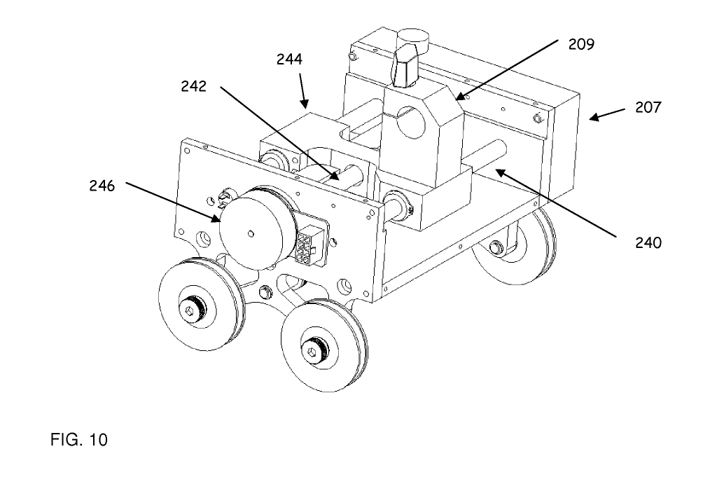

FIG. 10 shows a close-up of the details of the transverse sliding axis drive unit (207) that includes slide rails (240), slide lead screw (242), slide bearing and screw nut assembly (244), slide drive motor (246) and rotational quick mount (209).

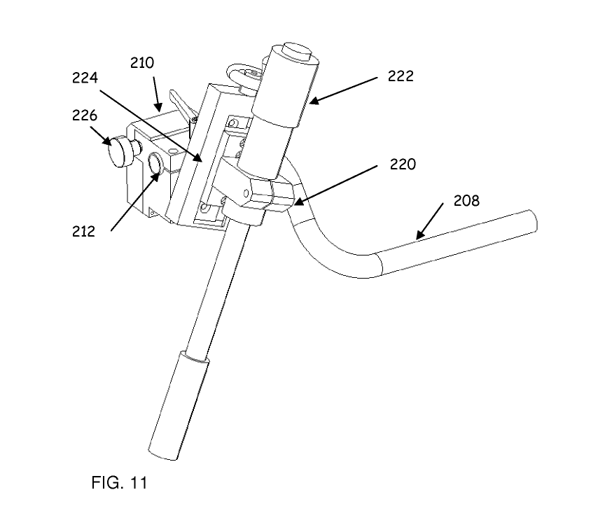

FIG. 11 shows the details of the torch toolbar and torch holder unit with torch attached. The torch holder (210) attaches to the torch toolbar (208) through a rotational quick mount (212). The torch holder provides a translational degree of freedom, torch depth and an orientation degree of freedom, work angle. The torch (222) mounts in the torch holder through a rotational, adjustable depth quick connection (220). An adjustable torch depth control axis (224) can also be provided. An adjustable rotational control axis (226) to control work angle can also be provided.

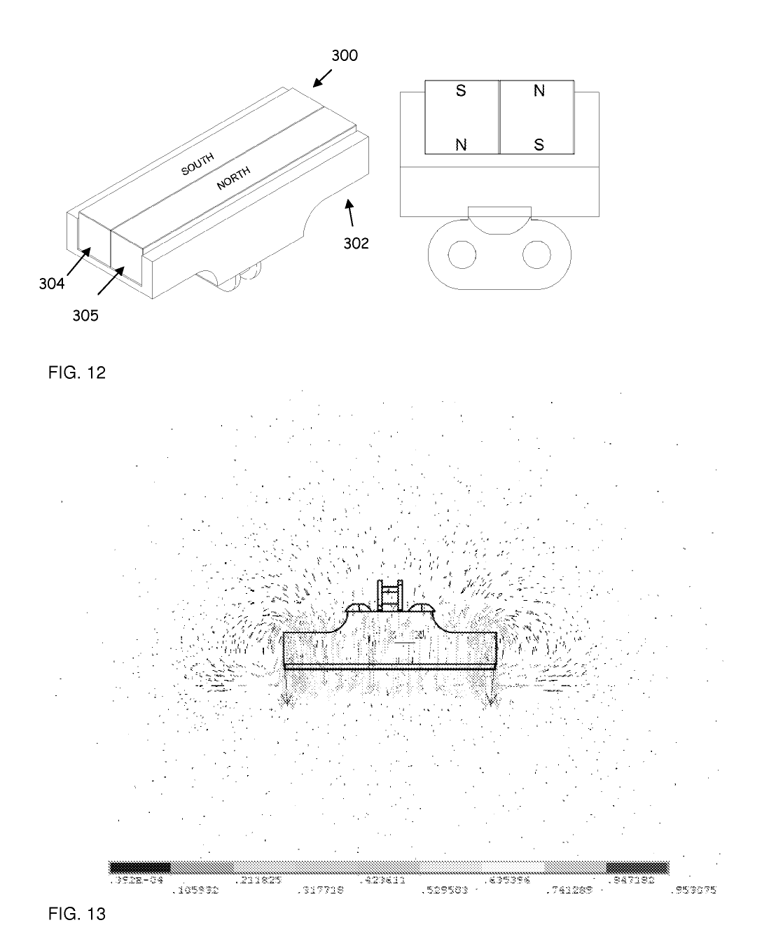

FIG. 12 shows an embodiment for the magnetic foot member (300). The magnetic foot has a support block (302), and a plurality of magnetic elements (304-305) rigidly connected to the support block. The magnetic elements are arranged in the support block with a preferred alignment of the magnetic poles on the magnetic elements.

FIG. 13 gives a pictorial illustration of the magnetic field around a single magnetic foot on a ferrous plate.

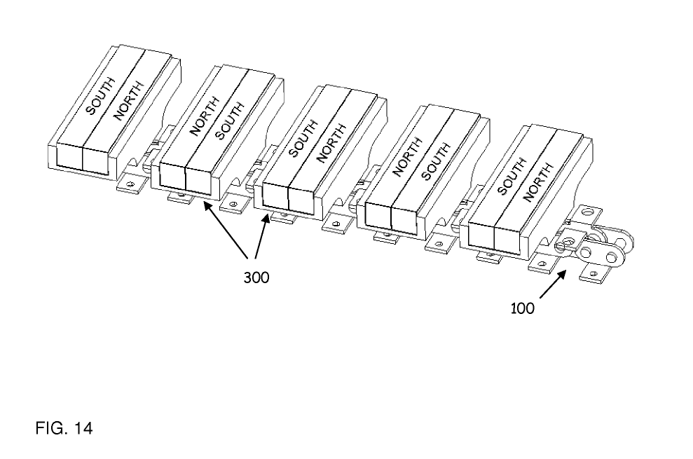

FIG. 14 shows a portion of the endless track (100) with a plurality of magnetic feet (300), a portion of those in contact with a large ferrous plate. Each magnetic foot (300) foot is properly oriented and attached to the endless track such that it contributes to the magnetic field in a preferred manner.

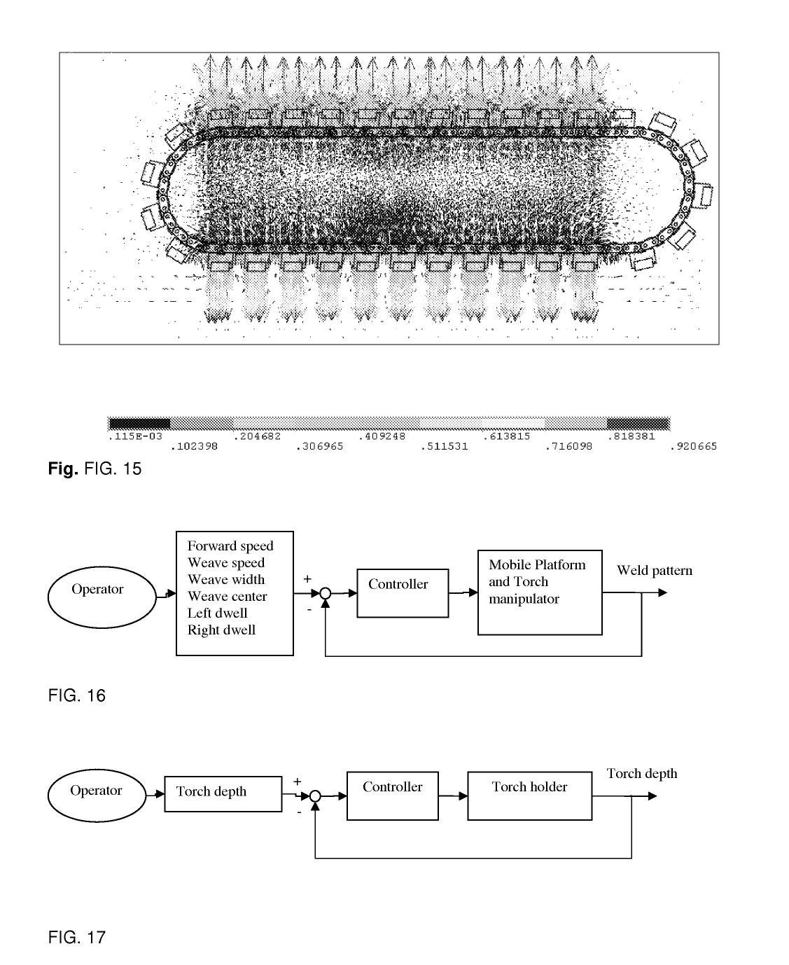

FIG. 15 gives a pictorial illustration of the magnetic field around two endless track units on a large ferrous plate. Note that the preferred manner of the field keeps the highest density of field lines closely located to the permanent magnet feet and ferrous wall surface. Note that the maximum field magnitude component is less than 5 gauss when measured 20 mm or greater away from any magnetic foot.

FIGS. 16 through 21 show a series of block diagrams that present the overall control system for the mobile robotic welding system. This diagram demonstrates the following aspects:

FIG. 16 shows a flow chart for closed loop control on torch pattern, which coordinates control of forward travel speed, lateral travel motion (position, velocity, dwells at the end positions).

FIG. 17 shows a flow chart for a closed loop control on torch motion along the axis of the torch.

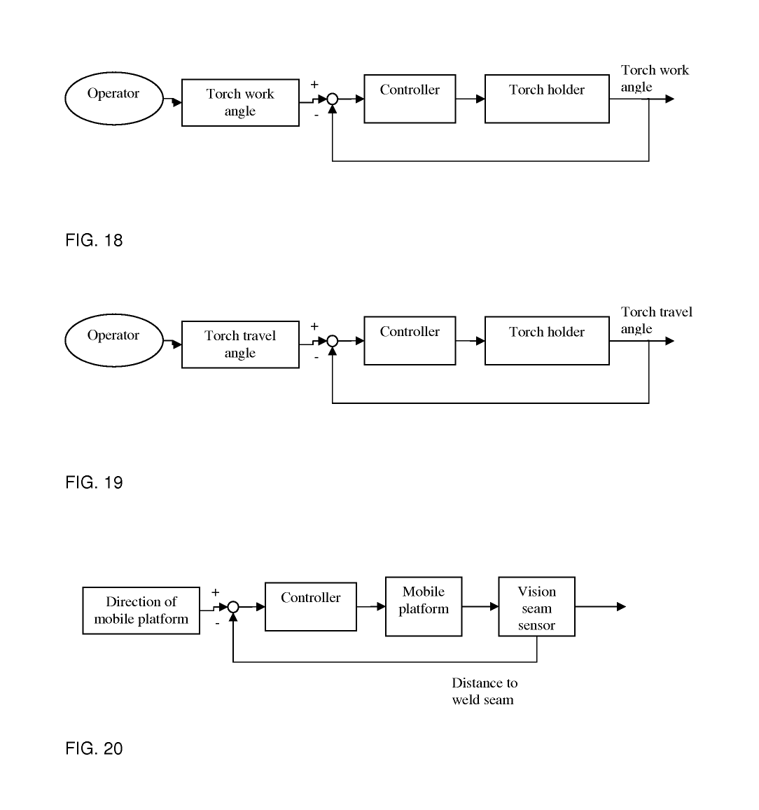

FIG. 18 shows a flow chart for closed loop control of torch work angle (rotation about the axis of the weld seam).

FIG. 19 shows a flow chart for closed loop control of torch travel angle (rotation about an axis perpendicular to the weld seam and parallel to the climbing surface).

FIG. 20 shows a flow chart for closed-loop control of the distance between the center-line of the robot and the weld seam.

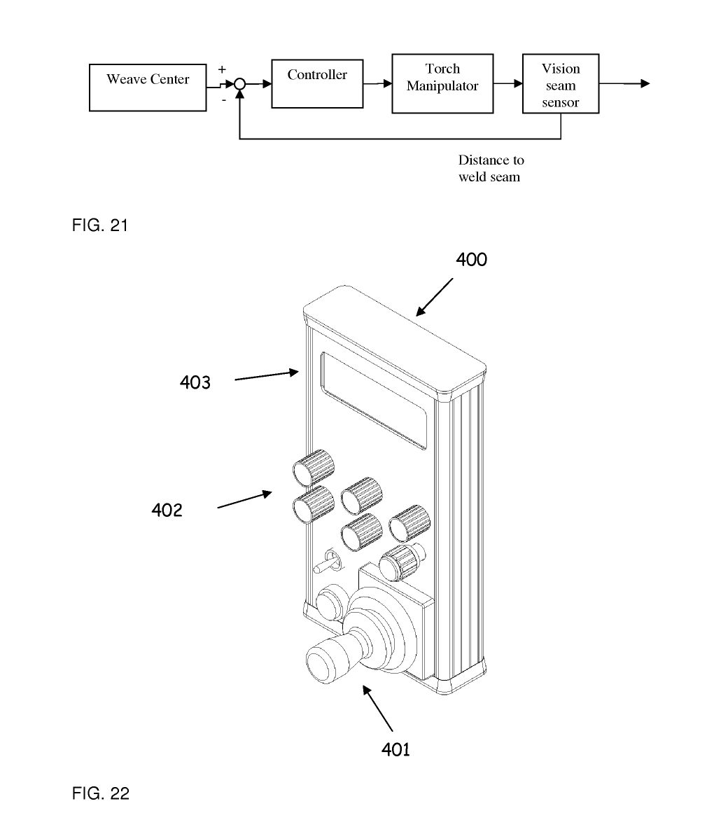

FIG. 21 shows a flow chart for closed-loop control of the distance from the torch center to the axis of the weld seam.

FIG. 22 shows a hand-held controller (400) that is used by an operator to control the endless track vehicle during operation. The controller includes a joystick (401) for general purpose motions and a series of control input dials (402) for defining task specific motion information. The controller contains a display (403) to present information to the operator in a character and or graphical presentation.

What is claimed is:

1. A trackless mobile device for mechanization of welding or other manufacturing tasks on metal work surfaces in all positions comprising
a chassis,
an endless track revolving about the chassis having an interior portion and an exterior portion, with a plurality of magnetic members capable of producing an attracting force with the climbing surface and attached to the exterior portion of the endless track and a protrusion such as a flange or rolling element attached to the inner portion of the endless track,
a drive mechanism attached to the chassis comprising a drive wheel and drive source, with the drive wheel engaging the interior portion of the endless track for driving the endless track,
a suspension apparatus comprising a track link guide, a force distribution member, and a track tensioning device,
the track link guide further comprising a plurality of suspension links, the suspension having an adjacent suspension link, the suspension link further having an interior and exterior portion, the interior portion having a slot, with the slot dimensions configured to mate with the protrusion of the endless track in a slidable manner, the suspension link connected to the adjacent suspension link with a pivot or slidable connections with the pivots or the slidable connections positioned to maintain a slidable transition of the slot along the suspension links,
the force distribution member such as a spring connecting the track link guide to the chassis, the force distribution member selected to uniformly distribute the forces required for climbing along the endless track and the adhering force members,
a carriage comprising a carriage link, a carriage spring and a carriage wheel, the carriage wheel affixed to the carriage through a revolute joint and positioned to be in contact with the climbing surface, the carriage link with one link end connected to the carriage through a revolute joint and a second link end connected to the chassis through a revolute joint with the carriage and the wheel generally aligned parallel to the endless track, the carriage spring with one spring end connected to the carriage link and a second spring end connected to the chassis to place a force on the carriage directed toward the climbing surface,
a tool bar with one bar end connected to the carriage through a slidable axis and a tool mounting bracket affixed through a mounting means on a second bar end, with the longitudinal axis of the slidable axis generally orthogonal to the longitudinal axis of the endless track

2. A device as in claim 1 in which the tool bar can be adjusted manually to hold the tool at different positions and orientations relative to the workpiece.

3. A device as in claim 1 in which a control interface that allows setting and adjustment of the endless track and tool bar slidable axis motion along the surface of the work piece and allows these settings to be changed during the tool operation to maintain a desired tool performance.

4. A device as in claim 1 in which the tool bar mounting device can be adjusted with actuators to hold the tool at different positions and orientations relative to the work piece, and the actuators controlled through the control interface.

5. A device as in claim 1 in which the permanent magnets attached to the endless tracks are designed in a way to have a prescribed magnetic field passing through the base material that, when using a tool whose operation may be affected by the presence of a certain level of magnetic field, minimizes the interaction of the magnetic field generated by the permanent magnets in the work piece.

6. A device in claim 1 in which a suitable sensor is attached to the vehicle and can provide spatial information about the manufacturing task to the control interface.

7. A device as in claim 1 in which a suitable sensor is attached to the vehicle to provide spatial information about the manufacturing task and a control method is implemented in the control interface to use the manufacturing task sensor information to adapt vehicle and tool motion to maintain an initial setting and adjustment of the tool motion.

8. A device as in claim 1 in which a control method is implemented in the control interface to predict corrections to the tool motion from the manual inputs during the tool operation and use the predicted corrections to adapt vehicle tool motion to maintain a preferred tool motion.

9. A devices as in claim 1 in which the carriage and the carriage link can be attached to the chassis in a modular and reconfigurable arrangement to position the tool anywhere inside, outside or around the platform within a minimal distance of the permanent magnet tracks, inside or outside, in front or behind, to act on a large range of manufacturing task configurations.

10. A trackless mobile device for mechanization of welding or other manufacturing tasks on metal work surfaces in all positions comprising
a chassis,
an endless track revolving about the chassis having an interior portion and an exterior portion, with a plurality of magnetic members capable of producing an attracting force with the climbing surface and attached to the exterior portion of the endless track and a protrusion such as a flange or rolling element attached to the inner portion of the endless track,
a drive mechanism attached to the chassis comprising a drive wheel and drive source, with the drive wheel engaging the interior portion of the endless track for driving the endless track,
a suspension apparatus comprising a track link guide, a force distribution member, and a track tensioning device,
the track link guide further comprising a plurality of suspension links, the suspension having an adjacent suspension link, the suspension link further having an interior and exterior portion, the interior portion having a slot, with the slot dimensions configured to mate with the protrusion of the endless track in a slidable manner, the suspension link connected to the adjacent suspension link with a pivot or slidable connections with the pivots or the slidable connections positioned to maintain a slidable transition of the slot along the suspension links,
the force distribution member such as a spring connecting the track link guide to the chassis, the force distribution member selected to uniformly distribute the forces required for climbing along the endless track and the adhering force members,
a tool bar with one bar end connected to the chassis through a slidable axis and a tool mounting bracket affixed through a mounting means on a second bar end, with the longitudinal axis of the slidable axis generally orthogonal to the longitudinal axis of the endless track

11. A device as in claim 10 in which the tool bar can be adjusted to hold the tool at different positions and orientations relative to the workpiece.

12. A device as in claim 10 in which the permanent magnets attached to the endless tracks are designed in a way to have a prescribed magnetic field passing through the base material that, when using a tool whose operation may be affected by the presence of a certain level of magnetic field, minimizes the interaction of the magnetic field generated by the permanent magnets in the work piece.

13. A trackless mobile device for mechanization of welding or other manufacturing tasks on metal work surfaces in all positions comprising
a chassis,
an endless track revolving about the chassis having an interior portion and an exterior portion, with a plurality of magnetic members capable of producing an attracting force with the climbing surface and attached to the exterior portion of the endless track and a protrusion such as a flange or rolling element attached to the inner portion of the endless track,
a drive mechanism attached to the chassis comprising a drive wheel and drive source, with the drive wheel engaging the interior portion of the endless track for driving the endless track,
a suspension apparatus comprising a track link guide, a force distribution member, and a track tensioning device,
the track link guide further comprising a plurality of suspension links, the suspension having an adjacent suspension link, the suspension link further having an interior and exterior portion, the interior portion having a slot, with the slot dimensions configured to mate with the protrusion of the endless track in a slidable manner, the suspension link connected to the adjacent suspension link with a pivot or slidable connections with the pivots or the slidable connections positioned to maintain a slidable transition of the slot along the suspension links,
the force distribution member such as a spring connecting the track link guide to the chassis, the force distribution member selected to uniformly distribute the forces required for climbing along the endless track and the adhering force members,
a carriage comprising a carriage link, a carriage spring and a carriage wheel, the carriage wheel affixed to the carriage through a revolute joint and positioned to be in contact with the climbing surface, the carriage link with one link end connected to the carriage through a revolute joint and a second link end connected to the chassis through a revolute joint with the carriage and the wheel generally aligned parallel to the endless track, the carriage spring with one spring end connected to the carriage link and a second spring end connected to the chassis to place a force on the carriage directed toward the climbing surface,
a tool bar with one bar end connected to the carriage through a slidable axis and a tool mounting bracket affixed through a mounting means on a second bar end, with the longitudinal axis of the slidable axis generally orthogonal to the longitudinal axis of the endless track
a control interface that allows setting and adjustment of the tool motion along the surface of the work piece and allows these settings to be changed during the tool operation to maintain a desired tool performance.

14. A device as in claim 13 in which the tool bar can be adjusted to hold the tool at different positions and orientations relative to the workpiece.

15. A device as in claim 13 in which the permanent magnets attached to the endless tracks are designed in a way to have a prescribed magnetic field passing through the base material that, when using a tool whose operation may be affected by the presence of a certain level of magnetic field, minimizes the interaction of the magnetic field generated by the permanent magnets in the work piece.

16. A device as in claim 13 in which a control method is implemented in the control interface to predict corrections to the tool motion from the manual inputs during the tool operation and use the predicted corrections to adapt vehicle tool motion to maintain a preferred tool motion.
